(19) United States
(12) Patent Application Publication
(10) Pub. No.: US 2014/0109563 A1
(43) Pub. Date: Apr. 24, 2014

(54) METHOD AND APPARATUS FOR STORING ENERGY USING A COMBINED HEAT AND PRESSURE STORAGE DEVICE

(71) Applicant: ADENSIS GMBH, Dresden (DE)

(72) Inventors: TIM MUELLER, OTTENDORF-OKRILLA (DE); BERNHARD BECK, VOLKACH OT DIMBACH (DE)

(73) Assignee: ADENSIS GMBH, Dresden (DE)

(21) Appl. No.: 14/139,977

(22) Filed: Dec. 24, 2013

Related U.S. Application Data
(63) Continuation of application No. PCT/EP2012/002511, filed on Jun. 14, 2012.

(30) Foreign Application Priority Data
Jun. 24, 2011 (DE) 102011105542.1

(51) Int. Cl. F15B 1/027; F03G 6/00

(52) U.S. Cl. CPC F15B 1/027; F03G 6/001
USPC 60/327; 60/412

(57) ABSTRACT

A method for storing energy using a combined heat and pressure storage device, includes mixing a gaseous first component and a liquid second component in an initial first step at a first pressure/temperature point to form a working medium. The working medium is compressed in a following step in such a way that the working medium has a second pressure/temperature point, at which the second component is at least partially gaseous. The compressed working medium is led into the combined heat and pressure storage device and stored there. In order to recover the energy, the working medium is expanded, whereupon the second component is at least partially liquefied. An apparatus for implementing the method is also provided.

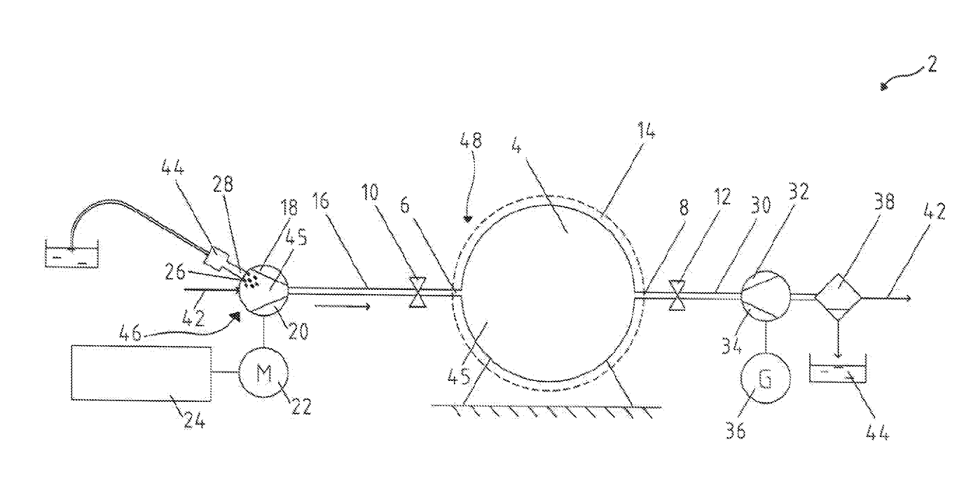

### CROSS-REFERENCE TO RELATED APPLICATION

This is a continuation, under 35 U.S.C. §120, of copending International Application No. PCT/EP2012/002511, filed Jun. 14, 2012, which designated the United States; this application also claims the priority, under 35 U.S.C. §119, of German Patent Application DE 10 2011 105 542.1, filed Jun. 24, 2011; the prior applications are herewith incorporated by reference in their entirety.

### BACKGROUND OF THE INVENTION

### Field of the Invention

The invention relates to a method for storing energy using a combined heat and pressure storage device, as well as an apparatus operating according to the method.

Electrical energy is usually stored by accumulators or capacitors, but the manufacture thereof is cost-intensive. Their use in the storage of comparatively large quantities of electrical energy is therefore uneconomical. Alternatives thereto are so-called pumped storage power stations. In that case water is usually pumped out of one reservoir into a geographically higher situated reservoir. The recovery of the energy is realized by the water being re-fed into the lower situated reservoir. Traditionally, the water in that case drives a turbine, and that in turn drives a generator for the production of electrical energy. A drawback thereof is that comparatively large-volume reservoirs, preferably in the form of lakes, as well as a gradient in the landscape, must be present to ensure an economical operation.

Another option for the storage of energy is presented by pneumatic energy storage devices, which are also referred to as compressed air storage power stations. In that case, with the aid of the energy, air is usually compressed and passed into a pressure storage device, for instance in the form of a natural cavern. The air is led into an expansion machine, which in turn drives an electric generator for the recovery.

As the air is compressed, it is warmed. Should that heat not be utilized, then the efficiency of the compressed air storage power station is extremely limited. Heat storage devices are therefore traditionally used for utilization of the heat. They are connected, for instance, upstream of the compressed air storage device, so that the compressed air is cooled before being led into the compressed air storage device. As an alternative thereto, the heat storage devices are thermally coupled to the compressed air storage device or are positioned therein, in which case the heat storage device must be constructed to be pressure-resistant.

### SUMMARY OF THE INVENTION

It is accordingly an object of the invention to provide an effective and, in particular, cost-effective method and a corresponding apparatus for storing energy using a combined heat and pressure storage device, which overcome the hereinafore-mentioned disadvantages of the heretofore-known methods and apparatuses of this general type.

With the foregoing and other objects in view there is provided, in accordance with the invention, a method for storing energy using a combined heat and pressure storage device. The method provides that, at a first pressure/temperature point, a first component and a second component are mixed to form a working medium or fluid. A pressure/temperature point is understood herein to be a point within a so-called phase diagram. In other words, a pressure/temperature point indicates a specific temperature and an associated pressure. For instance, the temperature of the first pressure/temperature point amounts to between 5° C. and 30° C., and in particular between 10° C. and 20° C. The pressure of the first pressure/temperature point suitably amounts to between 0.5 bar and 2 bar, and expediently 1 atm. At the first pressure/temperature point, the physical state of the first component is gaseous and that of the second component is liquid.

The working medium is compressed in a following work step. The heat generated during the compression of the first component is at least partially absorbed by the second component to such an extent that it at least partially evaporates. In particular, the working medium is isothermally compressed during this phase. The working medium is compressed until such time as it has a second pressure/temperature point. Suitably, at the second pressure/temperature point both the first component and the second component exist fully as gas. The temperature amounts to, for instance, between 250° C. and 350° C., and in particular 300° C. The pressure expediently lies between 50 bar and 150 bar, in particular between 50 bar and 80 bar, preferably at 60 bar.

In a following work step, the compressed working medium is led into a combined heat and pressure storage device. Advantageously, the heat and pressure storage device is thermally insulated and has a relatively large capacity, in particular ≧1 m³, suitably between 20 m³ and 500 m³, and preferably between 50 m³ and 200 m³. The compressed working medium, and thus the energy contained in the working medium, is stored in the combined heat and pressure storage device. During storage, despite the insulation of the combined heat and pressure storage device, the working medium releases temperature to the environment or to the combined heat and pressure storage device itself. Due to the temperature release, and thus due to the fall in temperature of the working medium, the second component partially condenses out. Due to this condensation, the evaporation energy stored within the condensed part of the second component is liberated, so that the temperature of the working medium rises again.

Given a suitable choice of the first and second component and of the first and second pressure/temperature point, it is possible to keep the temperature of the working medium within the combined heat and pressure storage device constant over a comparatively long period, while the degree of mixing of the working medium continuously changes. The concentration of the second component within the gaseous part of the working medium namely decreases, wherein the condensed-out share of the second component collects on the floor of the combined heat and pressure storage device.

Where the energy stored within the heat/pressure storage device, in the form of the compressed working medium, is due to be recovered, the working medium is expanded. Advantageously, the expansion takes place in a controlled manner within a suitable machine, wherein the expanded working medium performs work. After the expansion, the working medium has a temperature lying (slightly) above the first pressure/temperature point, for instance 50° C. At least, the temperature of the working medium is such that the second component is partially liquid. After the expansion, the gaseous part of the working medium suitably exists as a saturated or partially saturated gas, but not as an oversaturated gas. In other words, only at most that portion of the second component which, mixed with the further component of the working medium, produces a gas having a so-called saturation vapor pressure which is above or equal to the pressure of the gaseous part of the working medium after the expansion is gaseous. The other part of the second component, on the other hand, is liquid.

In accordance with another mode of the invention, during the mixing of the first component with the second component, the latter is introduced as suspended matter into the first component. In particular, following the mixing, the working medium is fully, or at least partially, in the form of an aerosol. In this way, a comparatively good intermixing of the two components is enabled, wherein, during the subsequent compression of the working medium, substantially no drop in temperature occurs within the same.

In accordance with a further mode of the invention, the quantity of the second component in comparison to the quantity of the further components of the working medium is chosen in such a way that, during the storage of the working medium, the gaseous part of the working medium exists as a saturated or partially saturated gas. As was already stated in connection with the expansion of the working medium, during the storage only a share of the second component is therefore gaseous. In particular, the first and the second pressure/temperature points, as well as the quantity of the second component, are chosen in this case in such a way that, during a comparatively long storage of the working medium within the combined heat and pressure storage device, this portion is minimal. Hence, preferably, no condensing-out of the second component takes place.

In accordance with an added mode of the invention, suitably, the working medium is formed of the first and second components, ambient air is chosen as the first component and water as the second component. A cost-effective implementation of the method is thereby ensured. Furthermore, this means that there is no need to take measures which, in the event of a malfunction of the combined heat and pressure storage device, prevent an escape of the first and second components into the environment, as would be the case, for instance, if a toxic substance were used. Similarly, in particular where water and ambient air are used, a possible chemical reaction between the two components, given a suitable choice of the first and second pressure/temperature points, can be avoided.

In accordance with an additional mode of the invention, expediently, the working medium is led through a compressor inlet of a piston compressor into the latter and compressed therein. Advantageously, the first component and the second component are in this case mixed in the region of the compressor inlet of the piston compressor. This enables the time interval between the compression of the working medium and the creation thereof by the mixture of the first and the second component to be kept comparatively small. In this way, the two components remain comparatively well mixed, in particular where, at the first pressure/temperature point, the working medium exists in the form of an aerosol.

In accordance with yet another mode of the invention, a steam turbine can be used for the recovery of the energy from the working medium and the expansion of the working medium takes place within a piston engine. In this way, it is comparatively easily possible to avoid damage to the engine due to a water shock. In addition, the slow working speed (in comparison to a turbine) promotes the full recovery of the evaporation energy stored within the second component.

In accordance with yet a further mode of the invention, an electric generator is operatively connected to the piston engine. Thus, the energy stored within the compressed working medium is converted into electrical energy and can be fed, for instance in the event of a supply shortage, into the national grid. Suitably, the energy generated by a solar cell or a wind power station is used to compress the working medium. Viewed over a day, these energy suppliers usually have no constant power output. Where the energy generated by a solar cell or a wind power station is used to compress the working medium and electrical energy is generated upon expansion of the working medium, it is possible to feed into the grid a current which, viewed over a day, is as constant as possible, or to absorb peaks of power demand within the grid.

With the objects of the invention in view, there is also provided an apparatus for implementing the method, which comprises a combined heat and pressure storage device, which has an inlet and an outlet and advantageously has a capacity between 20 m³ and 500 m³, and in particular between 50 m³ and 200 m³. In this case the inlet can coincide with the outlet, i.e. just one valve, for instance, assumes the function of the inlet and the outlet. Suitably, however, the inlet is spatially separated from the outlet and, in particular, can be respectively closed off by a stop valve.

Located on the inlet side of the combined heat and pressure storage device is a compressor and, upstream thereof, an injector. Through the use of the injector, a liquid second component is introduced into a gaseous first component, so that these two components are mixed to form a working medium. The injector is connected to the compressor in such a way that the working medium is led from the injector to the compressor. This is realized, for instance, by comparatively low under pressure generated by the compressor and/or comparatively low overpressure generated by the injector.

The compressor, in turn, is connected to the inlet of the combined heat and pressure storage device, in particular in a pressure-resistant manner. The working medium can be compressed by the compressor, whereupon the second component at least partially evaporates. The compressed working medium is led through the inlet into the heat or pressure storage device and stored there.

An expansion machine, which is constructed to recover energy contained in the compressed first component and in the compressed and evaporated second component, is connected to the combined heat and pressure storage device, on the outlet side.

In accordance with another feature of the invention, at least either the compressor or the expansion machine, though preferably both, is/are realized as a piston engine. In this way, both a cost-effective operation of the apparatus and a comparatively simple containment of a possible water shock are enabled.

In accordance with a further feature of the invention, the compressor is operated by an electric motor. Suitably, the expansion machine drives an electric generator. In this way, where the apparatus includes both the electric motor and the electric generator, a comparatively cost-effective storage of electrical energy is enabled.

In accordance with an added feature of the invention, a condensate separator is disposed downstream of the expansion machine. Thus, after the completed expansion of the working medium, the two components are again separate and can be reused again. In particular, where ambient air and/or water is/are used as the first and second component, this/these can be delivered back to the environment after the completed expansion.

Other features which are considered as characteristic for the invention are set forth in the appended claims.

Although the invention is illustrated and described herein as embodied in a method and an apparatus for storing energy using a combined heat and pressure storage device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SINGLE VIEW OF THE DRAWING

The single FIGURE of the drawing is a schematic and diagrammatic view of an apparatus with which an illustrative embodiment for implementing the method according to the invention will be explained in greater detail.

### DETAILED DESCRIPTION OF THE INVENTION

Referring now in detail to the single FIGURE of the drawing, there is seen an apparatus 2 which includes a combined heat and pressure storage device 4 having an inlet 6 and an outlet 8, which can be shut off by respective valves 10 and 12. The combined heat and pressure storage device 4 has, for instance, a cylindrical or capsular shape. The diameter of the combined heat and pressure storage device 4 is between 2 m and 6 m, and its length is between 5 m and 20 m. The combined heat and pressure storage device 4 is preferably made of glass-fiber-reinforced plastic (GFP) and is surrounded by an insulating layer 14. The insulating layer 14 serves for the thermal insulation of the combined heat and pressure storage device 4 from the environment and can also assume the function of a protection from mechanical damage. Traditional insulating materials made of mineral wool or polystyrene are conceivable, for instance, as the material of the insulating layer 14.

A compressor 18 is pneumatically connected, through a pressure-resistant pipe 16, to the valve 10 disposed upstream of the inlet 6. The compressor 18 is realized as a piston compressor 20 and is driven by an electric motor 22. The electric motor 22 is operated by electric energy generated by a solar cell 24. The compressor 18 has an inlet 26, into which an injector 28 opens.

An expansion machine 32 is pneumatically connected through a further pressure-resistant pipe 30 to the valve 12 disposed downstream of the outlet 8 of the combined heat and pressure storage device 4. The expansion machine 32 is in the form of a piston engine 34 and drives an electric generator 36. A condensate separator 38 is disposed downstream of the expansion machine 32.

A method for storing energy is implemented through the use of the apparatus 2. The energy is generated by the solar cell 24 and serves to drive the compressor 18. The compressor 18 suctions or sucks-in a first component 42, which is ambient air. A liquid second component 44, acting as a suspended matter, is introduced into the compressor 18 in the region of the compressor inlet 26, by the injector 28, so that a working medium or fluid 45 in the form of an aerosol is formed. The second component 44 is water.

The ratio of the first component 42 to the second component 44 within the working medium 45 is preferably 5:2. This means that 200 g of water is injected into a kilogram of suctioned or sucked-in air. The first component 42, the second component 44 and the created working medium 45 have a first pressure/temperature point 46. In other words, the temperature of the first component 42, of the second component 44 and of the created working medium 45 is substantially equal and amounts to between 10° C. and 30° C., and the pressure is the air pressure prevailing in the environment of the apparatus 2, i.e. atmospheric pressure.

Through the use of the compressor 18, the working medium 45 is compressed to 60 bar. Due to the compression, the temperature of the working medium 45 rises to about 300° C., so that the working medium 45 has a second pressure/temperature point 48. Due to the pressure or temperature, which is raised in comparison to the first pressure/temperature point 46, the second component 44 is fully evaporated. Energy is thus stored, within the working medium 45, at the second pressure/temperature point 48, in comparison to the first pressure/temperature point 46, inter alia in the form of evaporation energy.

The compressed working medium 45 is led through the pipe 16 and the valve 10 into the combined heat and pressure storage device 4 with the valve 12 being locked. After this, the valve 10 is closed and the compressed working medium 45 and the energy contained therein are stored within the combined heat and pressure storage device 4. During the storage, dissipated heat from the working medium 45 is delivered to the combined heat and pressure storage device 4, and through its insulating layer 14 to the environment. As a consequence, the temperature of the working medium 45 falls below the boiling point of the second component 44 at the pressure prevailing within the combined heat and pressure storage device 4. The second component 44 therefore partially begins to condense, whereupon evaporation energy in the form of an increase in temperature of the working medium 45 is released. In this way, the temperature of the working medium 45 stabilizes at about 275° C., whereby the second component 44 increasingly condenses out, is deposited on the walls of the combined heat and pressure storage device 4 and collects in its floor region.

In order to reconvert the stored energy, the valve 12 is opened and the working medium 45 is led through the outlet 6 and the pipe 30 into the expansion machine 32. There the working medium 45 is expanded, whereupon work is performed at the piston engine 34. The generator 36 operatively connected to the expansion machine 32 converts the work into electrical energy. During the expansion of the working medium 45 within the expansion machine 32, the working medium 45 cools and its pressure drops. The second component 44 thus liquefies and, on one hand, condenses within the expansion machine 32 and, on the other hand, exists as suspended matter within the first component 42. This aerosol is led into the condensate separator 38, and the first component 42 is separated from the second component 44. The first component 42 is thereupon led into the environment, whereas the second component 44 is collected so as to be available for a further storage cycle. Similarly, it would also be conceivable, however, to lead the second component 44 likewise into the environment, for instance into an outflow.

1. A method for storing energy using a combined heat and pressure storage device, the method comprising the following steps:
mixing a gaseous first component and a liquid second component at a first pressure/temperature point to form a working medium;
compressing the working medium to provide the working medium with a second pressure/temperature point, at which the second component is at least partially gaseous;
leading the compressed working medium into and storing the compressed working medium in the combined heat and pressure storage device; and
expanding the working medium to at least partially liquefy the second component, for recovery of the energy.

2. The method according to claim 1, which further comprises, during the mixing step, introducing the second component, as suspended matter into the first component, causing the working medium, at the first pressure/temperature point, to be at least partially in the form of an aerosol.

3. The method according to claim 1, which further comprises selecting a portion of the second component within the working medium being sufficient to cause a gaseous part of the working medium to exist as a saturated or partially saturated gas, during the storage of the working medium.

4. The method according to claim 1, which further comprises selecting at least one of ambient air as the first component or water as the second component.

5. The method according to claim 1, which further comprises carrying out the step of compressing the working medium by using a piston compressor having a compressor inlet.

6. The method according to claim 5, which further comprises carrying out the step of mixing the first component and the second component in vicinity of the compressor inlet of the piston compressor.

7. The method according to claim 1, which further comprises carrying out the step of expanding the working medium in a piston engine.

8. The method according to claim 7, which further comprises operatively connecting an electric generator to the piston engine.

9. The method according to claim 1, which further comprises using electrical energy generated by a solar cell to compress the working medium.

10. An apparatus for storing energy, the apparatus comprising:
a compressor configured to receive a gaseous first component and a liquid second component, configured to mix the first and second components at a first pressure/temperature point to form a working medium and configured to compress the working medium;
a combined heat and pressure storage device having an inlet downstream of said compressor and an outlet, said combined heat and pressure storage device configured to receive and store the compressed working medium at a second pressure/temperature point at which the second component is at least partially gaseous; and
an expansion machine disposed downstream of said outlet of said combined heat and pressure storage device and configured to expand the working medium to at least partially liquefy the second component, for recovery of the energy.

11. The apparatus according to claim 10, wherein said combined heat and pressure storage device has a capacity of ≧1 m³.

12. The apparatus according to claim 10, wherein at least one of said compressor or said expansion machine is a piston engine.

13. The apparatus according to claim 10, which further comprises an electric motor or an electric generator operatively connected to at least one of said compressor or said expansion machine.

14. The apparatus according to claim 13, which further comprises a solar cell operating said electric motor.

15. The apparatus according to claim 10, which further comprises a condensate separator disposed downstream of said expansion machine.

16. The apparatus according to claim 10, which further comprises an injector configured to supply the second component to said compressor.
